(19) United States
(12) Patent Application Publication
(10) Pub. No.: US 2009/0166535 A1
(43) Pub. Date: Jul. 2, 2009

(54) TRANSMISSION ELECTRON MICROSCOPY ANALYSIS METHOD USING FOCUSED ION BEAM AND TRANSMISSION ELECTRON MICROSCOPY SAMPLE STRUCTURE

(75) Inventor: Dong Kyo KIM, Seoul (KR)

Correspondence Address: Workman Nydegger;1000 Eagle Gate Tower, 60 East South Temple, Salt Lake City, UT, 84111, US

(73) Assignee: DONGBU HITEK CO., LTD., Seoul (KR)

(21) Appl. No.: 12/266,417

(22) Filed: Nov. 6, 2008

(30) Foreign Application Priority Data
Dec. 26, 2007 (KR) 10-2007-0137122

(51) Int. Cl. G01N 23/00

(52) U.S. Cl. 250/307; 250/311

(57) ABSTRACT

A TEM (transmission electron microscopy) analysis method using FIB (focused ion beam) includes dividing a TEM sample into a plurality of analysis regions; determining an FIB beam current for each of the analysis regions; and performing FIB milling on each of the analysis regions by using the determined FIB beam current. Further, the method includes loading the TEM sample onto a TEM sample grid and transmitting a TEM electron beam on the TEM sample to perform the TEM analysis.

### CROSS-REFERENCE TO RELATED APPLICATION

This application claims priority to Korean Application No. 10-2007-0137122, filed on Dec. 26, 2007, which is incorporated herein by reference in its entirety.

### BACKGROUND

1. Field of the Invention

Embodiments of the present invention relate to a TEM (Transmission Electron Microscopy) analysis method using FIB (Focused Ion Beam) and a TEM sample structure.

2. Description of Related Art

TEM analysis is made on a TEM sample loaded onto a TEM sample grid. A TEM electron beam passes through an analysis region on the TEM sample to make a TEM image so that various defects can be analyzed.

Among various techniques used to prepare the TEM sample, FIB milling is a relatively new and powerful technique. Because a FIB can be used to micro-machine samples very precisely, it is possible to mill very thin membranes from a specific area of a sample, such as a semiconductor or metal. Accordingly, an accurate TEM analysis can be made by performing FIB milling on the analysis region of the TEM sample.

However, the conventional TEM analysis, in which the TEM electron beam passes through a wide and thin sample, cannot achieve effective analysis results when defects are concentrated on a specific point. That is, though analysis on a wide area can be made by using a thin sample prepared by the FIB milling, analysis on a specific point cannot be made precisely due to refraction and diffraction of the electron beam over an area including the specific point.

### SUMMARY OF SOME EXAMPLE EMBODIMENTS

In general, example embodiments of the invention relate to an a TEM analysis method using FIB and a TEM sample structure, in which the TEM sample is divided into a plurality of analysis regions having different thicknesses therebetween to reduce an analysis failure rate and improve analysis accuracy and reliability.

In accordance with a first embodiment, there is provided a TEM analysis method using FIB, the method including: dividing a TEM sample into a plurality of analysis regions; determining an FIB beam current for each of the analysis regions; performing FIB milling on each of the analysis regions by using the determined FIB beam current; and loading the TEM sample onto a TEM sample grid and transmitting a TEM electron beam on the TEM sample to perform the TEM analysis.

The analysis regions may be divided into a first analysis region through which the TEM electron beam passes roughly, a second analysis region through which the TEM electron beam passes more cleanly than through the first analysis region, and a third analysis region through which the TEM electron beam passes more cleanly than through the second analysis region.

The FIB beam current used for performing FIB milling on the first analysis region may be in a range from about 950 pA to about 1050 pA.

The FIB beam current used for performing FIB milling on the second analysis region may be in a range from about 340 pA to about 360 pA.

The FIB beam current used for performing FIB milling on the third analysis region may be in a range from about 95 pA to about 100 pA.

Thicknesses of the analysis regions are different from each other. In addition, the analysis region positioned farthest from the TEM sample grid may be the thinnest analysis region.

In accordance with another embodiment, there is provided a TEM sample structure, wherein the TEM sample is divided into a plurality of analysis regions and the analysis regions are prepared by FIB milling using different FIB beam currents.

Thicknesses of the analysis regions may be different from each other. In addition, the analysis region positioned farthest from a TEM sample grid onto which the TEM sample may be loaded may be the thinnest analysis region.

The total length of the TEM sample may be in a range from about 10 μm to about 15 μm.

The length of the thinnest analysis region may be in a range from about 1 μm to about 2 μm.

The TEM sample may be divided into a first analysis region through which the TEM electron beam passes roughly, a second analysis region through which the TEM electron beam passes more cleanly than through the first analysis region, and a third analysis region through which the TEM electron beam passes more cleanly than through the second analysis region.

The FIB beam current used for performing FIB milling on the first analysis region may be in a range from about 950 pA to about 1050 pA.

The FIB beam current used for performing FIB milling on the second analysis region may be in a range from about 340 pA to about 360 pA.

The FIB beam current used for performing FIB milling on the third analysis region may be in a range from about 95 pA to about 100 pA.

Thus, the TEM sample is divided into a plurality of analysis regions and each of the analysis regions is prepared by using the FIB milling to have different thicknesses therebetween. Accordingly, the analysis failure rate can be reduced to improve analysis accuracy and reliability. Further, diffraction and interference of the TEM electron beam can be minimized, so that enhanced analysis and inspection can be performed as compared with the conventional analysis method.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

Aspects of example embodiments of the invention will become apparent from the following description of example embodiments given in conjunction with the accompanying drawings, in which:

FIG. 1 illustrates a structural diagram of a TEM sample prepared by using FIB in accordance with an embodiment of the present invention; and

FIG. 2 illustrates diffraction of a TEM electron beam when TEM analysis is performed on defects of the TEM sample in accordance with the embodiment of FIG. 1.

### DETAILED DESCRIPTION OF SOME EXAMPLE EMBODIMENTS

In the following detailed description of the embodiments, reference is made to the accompanying drawings that show, by way of illustration, specific embodiments of the invention. In the drawings, like numerals describe substantially similar components throughout the several views. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

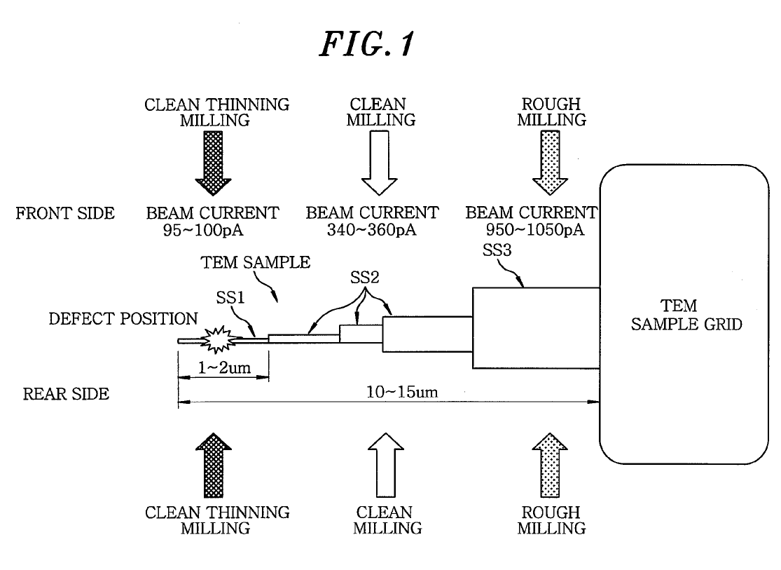

FIG. 1 illustrates a structural diagram of a TEM sample prepared by using FIB milling in accordance with an embodiment of the present invention. The TEM sample loaded onto a TEM sample grid is divided into a plurality of analysis regions, and FIB milling is performed on each of the analysis regions by using FIB beam currents which are different for each of the analysis regions.

In FIG. 1, the TEM sample may be divided into three analysis regions including a “rough milling” region SS3, a “clean milling” region SS2, and a “clean-thinning milling” region SS1.

The rough milling region SS3 is a region through which a TEM electron beam passes roughly and the FIB milling performed on this region may use an FIB beam current from about 950 pA (pico Ampere) to about 1050 pA. The clean milling region SS2 is a region through which the TEM electron beam passes more cleanly than through the rough milling region SS3 and the FIB milling performed on this region may use an IB beam current from about 340 pA to about 360 pA. The clean-thinning milling region SS1 is a region through which the TEM electron beam passes more cleanly than in the clean milling region and the FIB milling performed on this region may use an FIB beam current from about 95 pA to about 100 pA.

Performing the FIB milling on the TEM sample using the above described FIB beams causes a different thickness in each of the regions SS1 to SS3 such that the rough milling region SS3 is thickest, the clean milling region SS2 is less thick, and the clean-thinning milling region SS1 is the least thick, as shown in FIG. 1.

The total length of the TEM sample may be in a range from about 10 μm to about 15 μm, and the length of the clean-thinning region SS1 may be in a range from about 1 μm to about 2 μm. Accordingly, the TEM analysis method may be used for thickness measurement of a gate oxide film, measurement of an ONO (Oxide Nitride Oxide) structure, and quantitative and qualitative mapping of components.

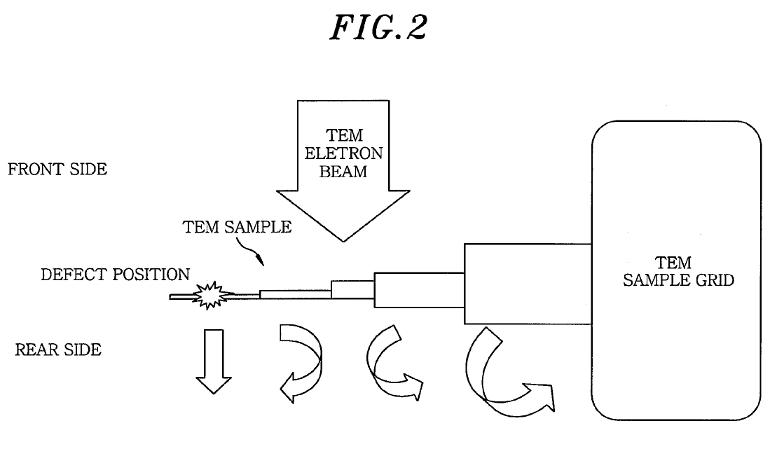

FIG. 2 illustrates diffraction of a TEM electron beam when TEM analysis is performed on defects of the TEM sample in accordance with the embodiment of FIG. 1.

As shown in FIG. 2, diffraction and interference of the TEM electron beam passing through the TEM sample increases with an increase of the thickness of the analysis region. That is, diffraction and interference of the TEM electron beam is minimized when it passes through the thinnest analysis region. Accordingly, if defects of the TEM sample are concentrated on a specific point of the thinnest analysis region, TEM analysis can be made much more precisely.

In accordance with the foregoing description, the TEM sample may be divided into a plurality of analysis regions and each of the analysis regions may be prepared by using FIB milling such that different regions have different thicknesses therebetween. Accordingly, an analysis failure rate can be reduced to improve analysis accuracy and reliability. Further, diffraction and interference of the TEM electron beam can be minimized, so that enhanced analysis and inspection can be performed as compared with a conventional analysis method.

While the invention has been shown and described with respect to an embodiment, it will be understood by those skilled in the art that various changes and modifications may be made without departing from the scope of the invention as defined in the following claims. Therefore, the scope of the present invention should be determined not by the embodiment illustrated, but by the appended claims and equivalents thereof.

What is claimed is:

1. A TEM (transmission electron microscopy) analysis method using FIB (focused ion beam), the method comprising:
dividing a TEM sample into a plurality of analysis regions;
determining an FIB beam current for each of the analysis regions;
performing FIB milling on each of the analysis regions by using the determined FIB beam current; and
loading the TEM sample onto a TEM sample grid and transmitting a TEM electron beam on the TEM sample to perform the TEM analysis.

2. The TEM analysis method of claim 1, wherein the analysis regions include a first analysis region through which the TEM electron beam passes roughly, a second analysis region through which the TEM electron beam passes more cleanly than through the first analysis region, and a third analysis region through which the TEM electron beam passes more cleanly than through the second analysis region.

3. The TEM analysis method of claim 2, wherein an FIB beam current used for performing FIB milling on the first analysis region is in a range from about 950 pA to about 1050 pA.

4. The TEM analysis method of claim 2, wherein an FIB beam current used for performing FIB milling on the second analysis region is in a range from about 340 pA to about 360 pA.

5. The TEM analysis method of claim 2, wherein an FIB beam current used for performing FIB milling on the third analysis region is in a range from about 95 pA to about 100 pA.

6. The TEM analysis method of claim 1, wherein thicknesses of the analysis regions are different from each other and the analysis region positioned farthest from the TEM sample grid is the thinnest analysis region.

7. A TEM (transmission electron microscopy) sample structure, wherein the TEM sample is divided into a plurality of analysis regions and the analysis regions are prepared by FIB (focused ion beam) milling using different FIB beam currents.

8. The TEM sample structure of claim 7, wherein thicknesses of the analysis regions are different from each other and the analysis region positioned farthest from a TEM sample grid onto which the TEM sample is loaded is the thinnest analysis region.

9. The TEM sample structure of claim 8, wherein a total length of the TEM sample is in a range from about 10 μm to about 15 μm.

10. The TEM sample structure of claim 8, wherein a length of the thinnest analysis region is in a range from about 1 μm to about 2 μm.

11. The TEM sample structure of claim 7, wherein the TEM sample is divided into a first analysis region through which the TEM electron beam passes roughly, a second analysis region through which the TEM electron beam passes more cleanly than through the first analysis region, and a third analysis region through which the TEM electron beam passes more cleanly than through the second analysis region.

12. The TEM sample structure of claim 11, wherein an FIB beam current used for performing FIB milling on the first analysis region is in a range from about 950 pA to about 1050 pA.

13. The TEM sample structure of claim 11, wherein an FIB beam current used for performing FIB milling on the second analysis region is in a range from about 340 pA to about 360 pA.

14. The TEM sample structure of claim 11, wherein an FIB beam current used for performing FIB milling on the third analysis region is in a range from about 95 pA to about 100 pA.
